(19) United States
(12) Patent Application Publication
(10) Pub. No.: US 2026/0187479 A1
(43) Pub. Date: Jul. 2, 2026

(54) Methods for Encoding and Decoding Data From Array-Based Sensing Systems

(71) Applicant: Stichting IMEC Nederland, Eindhoven (NL)

(72) Inventors: Hua-Peng Liaw, Tilburg (NL); Yuming He, Eindhoven (NL); Guangzhi Tang, Heeze (NL); Yao-Hong Liu, Eindhoven (NL); Venkata Sai Lohit Gandham, Delft (NL)

(21) Appl. No.: 19/431,296

(22) Filed: Dec. 23, 2025

(30) Foreign Application Priority Data
Dec. 30, 2024 (EP) 24223607.3

(51) Int. Cl. G06N 3/096; G06N 3/0455; G06N 3/049

(52) U.S. Cl. CPC G06N 3/096; G06N 3/0455; G06N 3/049

(57) ABSTRACT

Example embodiments describe computer-implemented methods for training a spiking neural network for encoding and decoding event information obtained from a set of sensors in an array-based sensing system. Further example embodiments describe a neural network training system as well as a sensor and an edge gateway device employing such encoding and decoding spiking neural networks.

### CROSS-REFERENCE TO RELATED APPLICATION(S)

The present application is a non-provisional patent application claiming priority to European Patent Application No. 24223607.3, filed Dec. 30, 2024, the contents of which are hereby incorporated by reference.

### FIELD OF THE DISCLOSURE

The present disclosure relates to encoding and decoding information from sensors with neural networks. More specifically, example embodiments of the present disclosure relate to methods, devices, and a system for training spiking neural networks, SNN, for encoding and decoding such information.

### BACKGROUND

Array-based sensing systems, which may be used in imaging or in detecting electrical signals, are becoming increasingly popular in a variety of applications. There is an increasing demand for more detailed information, corresponding to increasing number of channels in the array-based sensing systems and increasing resolution of information. Array-based sensing systems may generate information larger than 1 Gbps, which drastically increases the power consumption used not only for information capturing, but also for storage, processing, and transmission.

Further, such array-based sensing systems may be intended to be used in a remote location for collecting information in a location that may be hard to access. Thus, it would be useful that the array-based sensing systems may be deployed without maintenance for a long time. Further, it would be useful that the array-based sensing systems have a long lifetime and a long battery time. For example, array-based systems may be used in implanted devices for sensing biological signals and may handle more than 1 Gbps of information.

Furthermore, for array-based sensing systems used as implantable devices, low power consumption improves the lifetime of the device and provides longer-lasting batteries. Also, it may be useful for implantable devices to provide low operational temperatures, such as below 40 mW/cm² heat flux and 1° C., in order to maintain long-term tissue health and to minimize or prevent tissue damage from heat diffusion.

As data transfer and/or communication are contributors of power consumption in array-based sensing systems, efficient lossless or low-loss encoding and decoding of information in array-based sensing systems may be useful.

### SUMMARY

The present disclosure provides efficient encoding and decoding of information for array-based sensing systems to facilitate low power consumption and to provide a long lifetime. The present disclosure further provides an efficient lossless or low-loss encoding of information for such sensing systems to facilitate low heat dissipation, maintain long term tissue health, and prevent tissue damage from heat dissipation.

Data compression is the process of encoding information using fewer bits than its original format. Since most real-world data is not uniformly distributed, conventional data compression algorithms analyze raw data to capture its underlying statistical distribution and then encode the raw data using an encoding dictionary, such as Huffman coding, or a drop/quantize strategy, e.g., JPEG, to reduce data size. These approaches, however, are content-dependent or content-aware and thus are not suitable for array-based sensing systems where the underlying statistical distribution of the raw data is unknown or unavailable. Further, when developing data compression, there are three factors that may be taken into account, including the compression ratio, the algorithm and/or hardware complexity, and the computational resources. These factors are co-dependent and conflicting, making conventional data compression not suitable for such array-based sensing systems.

The disclosure is provided in the independent claims and herein. Example embodiments and features described herein that do not fall within the scope of the independent claims, if any, are to be interpreted as examples useful for understanding various embodiments of the disclosure.

According to a first example embodiment of the present disclosure, a computer-implemented method is provided for training a learning model for encoding event information with a learning system comprising a spiking neural network (SNN) and may include obtaining event information characterizing one or more events each corresponding to a change in a value of a sensor from a set of sensors. The method further may include deriving encoded representation from the obtained event information with an encoder-decoder neural network and training the SNN for encoding the event information with the obtained event information and the derived encoded representation.

The SNN is not (e.g., only) trained with the event information, but also with (e.g., by means of) the encoded representation. The encoder-decoder neural network and the SNN are employed in a teacher-student configuration. The use of a teacher-student architecture provides for the capabilities of a more complex, teacher network, e.g., the encoder-decoder neural network, to break down the complex transformation of the event information into several transformations to (e.g., easily) train a (e.g., much simpler) student network, even with limited learning capability, e.g., the SNN, to learn those transformations to achieve the same or similar performance as the complex teacher network. This allows a small, low-complexity SNN to perform a lossless or low-loss compression or encoding of event information in sensor devices in array-based sensing systems where power consumption specifications (e.g., requirements) are stringent. A lightweight SNN not only offers an optimum balance between the compression ratio, algorithm/hardware complexity, and computational resources, but also breaks co-dependency between them. Further, training the SNN in a teacher-student configuration may minimize having to understand the underlying statistical distribution of the event information, thus facilitating the usage of the SNN in array-based sensing systems where content-agnostic encoding or compression is also used. A lightweight SNN capable of lossless or low-loss compression not only offers an (e.g., optimum) balance between the three conflicting factors, e.g., compression ratio, algorithm/hardware complexity, and computational resources, but also breaks the conflict cycle between performance and complexity.

According to example embodiments, the SNN includes at least one hidden layer, and the SNN implements an integrate-and-fire model or a leaky integrate-and-fire model.

The SNN is flexible and may implement different types of learning models, such as integrate-and-fire or a leaky integrate-and-fire models, Hodgkin-Huxley Izhikevich model, or spike response model. Further, the SNN may be very lightweight as (e.g., only) two hidden layers are sufficient for lossless or low-less encoding.

According to example embodiments, the deriving includes training the encoder-decoder neural network using the obtained event information, and the encoder-decoder neural network includes a deep neural network (dNN), such as a feedforward neural network (FNN), a convolutional neural network (CNN), or a recursive neural network (RNN), such as a gated recurrent unit-based neural network (GRU) and a long short-term memory (LSTM) neural network.

The selection of the encoder-decoder neural network is also flexible. The selection of the encoder-decoder neural network does not affect the complexity nor the encoding performance of the SNN, e.g., the reconstruction error and the compression ratio, because the reconstruction error and the compression ratio are determined by the size of the encoded representation. Therefore, these also may be (e.g., easily) tuned in accordance with the application specifications (e.g., requirements) by varying the size of the encoded representation.

According to example embodiments, the method further includes deploying the trained SNN to a sensor device and the trained decoder neural network (DNN) to an edge gateway device. Deploying includes obtaining configuration parameters characterizing the trained SNN and the trained DNN, in addition to programming a replica SNN deployed on the sensor device and a replica DNN deployed on the edge gateway device with the obtained configuration parameters.

Deploying a first portion of the trained SNN to a sensor device and a remaining (e.g., second) portion of the trained SNN and a trained decoder neural network (DNN) to an edge gateway device. Deploying includes obtaining configuration parameters characterizing the trained SNN and the trained DNN, in addition to programming a replica of the first portion of SNN deployed on the sensor device, a replica of the remaining portion of the SNN, and a replica DNN deployed on the edge gateway device with the obtained configuration parameters.

The use of SNN provides (e.g., allows) for employing distributed encoding computation, such that an additional degree of freedom is provided when trading-off between computation and communication resources used by the sensor devices.

According to further example embodiments, the method includes obtaining event information characterizing one or more events, each corresponding to a change in a value of a sensor from a set of sensors, and inferring therefrom encoded representation with an SNN pre-trained by the method (e.g., according to the first example embodiment).

A computer-implemented method for training a learning model for decoding event information with a learning system comprising a spiking neural network (SNN), and the method includes obtaining event information characterizing one or more events each corresponding to a change in a value of a sensor from a set of sensors, deriving encoded representation from the obtained event information with an encoder-decoder neural network, and training the SNN for decoding the encoded representation with the obtained encoded representation and the derived event information.

According to example embodiments, the encoder-decoder neural network and the SNN may form a teacher-student neural network.

According to example embodiments, the deriving includes training the encoder-decoder neural network using the event information. The encoder-decoder neural network may be a deep neural network (dNN), such as a feedforward neural network (FNN), a convolutional neural network (CNN), or a recursive neural network (RNN), such as a gated recurrent unit-based neural network (GRU) and a long short-term memory (LSTM) neural network.

According to example embodiments, the SNN includes at least one hidden layer, and the SNN implements an integrate-and-fire model or a leaky integrate-and-fire model.

According to example embodiments, the method further includes deploying the trained SNN to an edge gateway device. The deploying includes obtaining configuration parameters characterizing the trained SNN and programming a replica SNN on the edge gateway device with the obtained configuration parameters.

According to a second example embodiment, a computer-implemented method includes obtaining encoded representation of event information characterizing one or more events, each corresponding to a change in a value of a sensor from a set of sensors, and inferring therefrom the event information with a SNN pre-trained by the method.

According to a third example embodiment, a sensor device includes a spiking neural network (SNN), pre-trained according to the method of the first example embodiment and configured to receive event information characterizing one or more events, each corresponding to a change in a value of a sensor from the set of sensors, and to infer encoded representation of received event information.

According to example embodiments, the SNN is pre-trained according to the method of the first example embodiment to partly encode the received event information.

The sensor device is thus provided with a lightweight SNN pre-trained for lossless or low-less and content-agnostic compression or encoding of event information. This provides the sensor device to be used in various applications such as an implantable edge device where a long lifetime or a long battery time is useful, when computation and memory resources are limited.

Further, the various example embodiments of the first example embodiment may be applied to other example embodiments, such as applied to the third example embodiment.

According to a fourth example embodiment, an edge gateway device includes a DNN pre-trained by the method according to method of the first example embodiment or a SNN pre-trained by the method according to the second example embodiment and configured to receive encoded representation of event information characterizing one or more events, each corresponding to a change in a value of a sensor from a set of sensors from, and to infer the event information encoded therein.

According to example embodiments, the edge gateway device may further include a SNN pre-trained by the method according to the first example embodiment and configured to receive (e.g., partly) encoded representation of the event information and to output the encoded representation of the event information.

By providing an edge gateway device with a lightweight SNN pre-trained for decoding the event information, the edge gateway device may provide the same uses or improvements as the sensor device of the third example embodiment.

Further, the various example embodiments of the second example embodiment may be applied to other example embodiments, such as applied to the fourth example embodiment.

According to a fifth example embodiment, a neural network training system includes at least one processor and at least one memory including computer program code. The at least one memory and computer program code are configured to, with the at least one processor, cause the neural network training system to perform the computer-implemented method according to the first example embodiment or the second example embodiment when the computer program code is run on the neural network training system.

According to a sixth example embodiment, a computer program product includes computer-executable instructions for causing at least one computer to perform the method according to the first example embodiment or the method according to the second example embodiment when the program is run on the at least one computer.

According to a seventh example embodiment, a computer readable storage medium includes the computer program product according to the sixth example embodiment.

The various example embodiments of the first and second example embodiments may be applied to other example embodiments, such as applied to the third and fourth example embodiments.

### BRIEF DESCRIPTION OF THE FIGURES

The above, as well as additional, features will be better understood through the following illustrative and non-limiting detailed description of example embodiments, with reference to the appended drawings.

FIG. 1A shows a sensor device and an edge gateway device according to an example embodiment of the present disclosure.

FIG. 1B shows a sensor device and an edge gateway device according to a first example embodiment of the present disclosure.

FIG. 2 shows a neural network training system according to a second example embodiment of the present disclosure.

FIG. 3A shows an example encoding and a decoding neural network architecture for the sensor device and the edge gateway devices of FIG. 1A.

FIG. 3B shows an example encoding and a decoding neural network architecture for the sensor device and the edge gateway devices of FIG. 1B.

FIG. 4 shows simulation results illustrating the compression ratio achieved with the encoding and decoding neural network architecture of FIG. 3A.

FIG. 5 shows an example embodiment of a computing system for performing one or several steps in embodiments of the disclosure.

All the figures are schematic, not necessarily to scale, and generally only show parts which are necessary to elucidate example embodiments, wherein other parts may be omitted or merely suggested.

### DETAILED DESCRIPTION

Example embodiments will now be described more fully hereinafter with reference to the accompanying drawings. That which is encompassed by the claims may, however, be embodied in many different forms and should not be construed as limited to the embodiments set forth herein; rather, these embodiments are provided by way of example. Furthermore, like numbers refer to the same or similar elements or components throughout.

To overcome the above challenges, the present disclosure proposes the use of a spiking neural network (SNN) for performing data compression on edge devices such as sensor devices in array-based sensing systems. The edge device here provides a device that provides an entry point into a processing unit. The edge gateway device processes data from edge devices, translates signals from an edge device using different protocols, and sends back relevant data. In the disclosure, the edge device may include sensors and perform (e.g., simple) processing. The edge gateway device processes or compresses data before transferring the data to a more powerful system. The edge gateway device may also send weights associated with the neurons in the edge device. The SNN is trained in a teacher-student configuration which allows for knowledge transfer from large, complex deep neural networks, e.g., the teacher, to a smaller, more lightweight neural networks, e.g., the students. The present disclosure further proposes the use of a SNN for decoding the compressed information, thus elevating the power and complexity constraints of the edge gateway devices.

Compared to encoder-decoder neural networks which transmit information between neurons in different layers in each propagation cycle, a SNN may convey information using discrete spikes incorporating the concept of time into its operation. Further, a SNN tends to exhibit sparse activation patterns, providing that (e.g., only) a small fraction of neurons fire spikes at any given time. This sparse activation reduces the overall energy consumption of the spiking neural network by minimizing computations and memory accesses. Despite the energy efficiency and biological plausibility, SNN may have relatively weak learning capabilities compared to other network architectures. The limited learning capability may hinder its ability to learn tasks of high-dimensional representation or fine-grained classification, such as encoding or compression of event information obtained from edge deployed infrastructure.

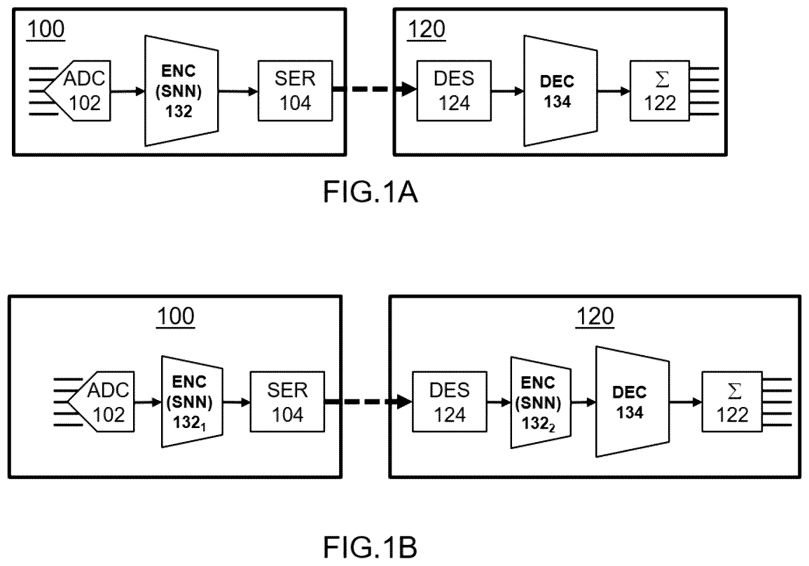

FIG. 1A shows a sensor device 100 for encoding the data from a set of sensors. The sensor device (e.g., edge device) 100 is configured to receive input from the set of sensors. The set of sensors may include a plurality of sensors. The sensors may be arranged in an array, such as being regularly ordered in rows and/or columns in the array. However, the plurality of sensors in the set may be arranged in any arrangement. The sensor device 100 may thus be connected to the sensors in the set for receiving the signals. Alternatively, the sensor device may be integrated with the sensors or may be separated from the sensors and configured to receive signals from the sensors through one or more wires. The sensor device may even be configured to receive signals from the one or more sensors using wireless communication with the one or more sensors. Further, the sensors in the set may (e.g., all) be the same type or may be different types. The set of sensors may, for instance, be configured to detect a biological signal, such as an electrical signal propagating through a tissue, such as a nerve. Thus, the set of sensors may include electrodes configured to detect electrical signals from biological tissue. However, the set of sensors may also include other types of sensors, such as photo-sensitive elements configured to detect imaging information or an optical signal, such as an intensity of incident light. The set of sensors may also include elements sensitive to a magnetic signal or a vibrational signal. The sensors may be arranged in an array allowing a spatial resolution of the detected signals. Each sensor in the set may be the same (e.g., identical), such that the sensors may be configured to detect a common type of signal, or, the sensors in the set may alternatively be of different types and thus detecting different types of signals of the monitored object or scene or of the different monitored objects or scenes, such as different parts of a body.

The received input may be provided to a plurality of analog-to-digital converters (ADCs), 102a, 102b, . . . , 102n wherein each ADC 102a-n may be connected to a subset of sensors, such as the set provided in European Patent Application No. 23213959.2. The subset of sensors may include one sensor. However, the subset of sensors may include a plurality of sensors, such that the ADC 102a-n may receive input from the subset of sensors in a time-multiplexed manner. The ADCs 102a-n are configured to detect events in input signals received from the sensors. Thus, each ADC 102a-n may be configured to detect changes in a value of an analog signal from a sensor, wherein such a change may correspond to an event. The ADCs 102a-n may be configured as level-crossing ADCs (LC-ADCs), which are configured to detect whether a value of a signal is above an upper threshold or below a lower threshold set in relation to a previous value of the signal. However, the ADCs 102a-n may be configured to detect events in another manner, such as the ADCs 102a-n comprising a comparator which determines whether an event has occurred after the value of the signal has been converted to digital format. Alternatively, the ADCs may be ADCs configured to operate at Nyquist rate, i.e., Nyquist-rate ADCs. The Nyquist-rate ADC may further be combined with a delta modulator such that the delta modulator provides an output (e.g., only) when a value of a signal input to the Nyquist-rate ADC changes.

The information output by the ADCs therefore characterizes the detected events in a digital format. Depending on the type of ADCs used, the event information may be an indication of an observed change of the value of the signal or the event information may be provided as a direction of change of the value of the signal (e.g., up or down) and, optionally, a magnitude of the change. For example, a single bit may represent the observed change of the signal value or the direction of change, and a number of bits may represent the change in magnitude of the signal. The output of an ADC may, for example, be a single-bit signal with each bit representing a change in the value of the sensor signal, e.g., detected events, or a multi-bit signal with each bit representing the signal from a sensor in a delta-modulated format.

With the use of event information for representing information from the set of sensors, a data rate produced by the set of sensors may be reduced. Thus, values of the signal from the sensor may not be provided in each time instance. Rather, the signal from the sensor may (e.g., only) be represented when a change of the value of the signal occurs. This implies that the sensor device 100 may output a limited amount of data, such that data communication is limited. This is useful in limiting power consumption.

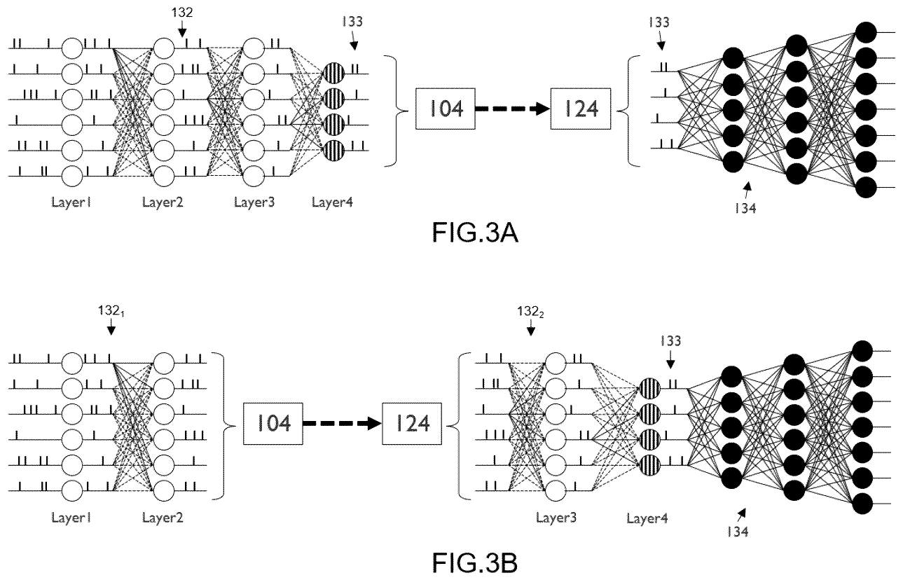

The sensor device 100 further includes an encoder, ENC (SNN) 132 pre-trained to encode the event information provided by the ADCs 102a-102n. The ENC 132 includes spiking neural network (eSNN) pre-trained to perform a lossless or low-less compression or encoding of the event information. The SNN 132 receives event information from the ADCs 102a-102n and derives or infers an encoded representation 133 (shown in at least FIGS. 3A and 3B) therefrom. This implies that the sensor device may be configured to encode or compress data from the same or different types of sensors, which may be configured to monitor common or different objects or scenes of interest.

FIG. 3A shows an example architecture of the encoding SNN (eSNN) 132. The eSNN 132 is a (e.g., fully) connected neural network comprising an input layer 1, Layer 1, two hidden layers, Layer 2 and Layer 3, and an output layer, Layer 4. The eSNN may implement biological neuron learning models, such as an integrate-and-fire or a leaky integrate-and-fire, or any other suitable (e.g., for the purpose) models. The neurons in a respective layer are (e.g., fully) connected to the neurons in both the preceding layer and the subsequent layer. However, the eSNN may have a partially-connected architecture. Depending on the type of sensors in the set and/or the type of information they acquire as well as their number, the eSNN may include more than two hidden layers. For example, two hidden layers are sufficient for providing (e.g., ensuring) lossless or low-less compression when the sensor device 100 is used to detect electrical signals from biological tissue. However, for other types of sensors such as an event camera, one hidden layer may be used (e.g., sufficient), while for others more hidden layers may be used (e.g., required). In the example of FIG. 3A, the output of the ADCs is fed to respective neurons in the input layer of the SNN 132. The neurons in the respective layers apply a linear or non-linear transformation to the received values from the ADCs in accordance with the learning model that the eSNN implements. For example, if a bias is included in the leaky-integrate-and-fire model, the neurons may apply a non-linear transformation. As a result, one or more neurons in a respective layer fire, e.g., each firing neuron generates a spike, which subsequently triggers the firing of neurons in the subsequent layers and thus outputs the encoded representation 133 at the output layer of the eSNN (e.g., the encoded event information obtained from the sensors).

For example, a (e.g., fully) connected SNN 132 with 3 hidden layers with 128, 128 and 64 leaky-integrate-and-fire neurons in the respective hidden layers may be employed to encode the event information obtained by the sensor device as described in the European Patent Application No. 23213959.2, while a (e.g., fully) connected RNN with 3-hidden layers with 64, 128 and 128 neurons in the respective layers may be used as the DEC 134. These SNN 132 and DEC 134 neural networks achieve an average of root mean square error among (e.g., all) channels of 4.76 μV, which is lower than the noise in the obtained event information, 5.9 μV.

Returning to FIG. 1A, the sensor device 100 may include a serializer (SER) 104 for generating a data packet representing the information acquired by the set of sensors. The data packet may be configured to include encoded representation of the event information generated or inferred by the SNN. The data packet may thus include encoded representation of event information generated during a time frame. The sensor device 100 may thus be configured to (e.g., continuously) monitor input signals from the eSNN 132, in a sequence of time frames. Each time frame may correspond to a time duration during which one or more encoded representations are derived by the eSNN. Hence, during a first time frame, one or more encoded representations are derived by the eSNN 132 from events detected by the ADCs 102a-n receiving input from respective sensors. These detected events are then encoded by the eSNN which derives therefrom the encoded representation. Thus, a data packet may contain encoded event information acquired from different sensors during a time frame.

Alternatively, the SER 104 may be activated (e.g., only) when encoded representation is received. For instance, if the sensors are used for sensing a biological signal, the information in the sensed biological signal may be very sparse. For example, if a neural signal is monitored by a sensor, the sensor may, during a major portion of time, detect a constant signal due to the sensor sensing no neural activity. The sensor may sense activity in the biological signal (e.g., only) during short periods of time. Thus, the sensor device 100 may be used for encoding data from sensors that sense sparse signals, since the sensing of sparse signals may imply that there are events (e.g., only) in a small fraction of time frames. The low power consumption provided by the sensor device may be useful for packetizing data when power supply is limited. Thus, if the set of sensors are used in an implanted or wearable system, power consumption may be very limited. This may imply that the sensor device 100 is suited for such applications, providing a long lifetime for an implanted or wearable device.

For efficient transfer of the one or more encoded representations from the edge device 100 to an external device, such as an edge gateway device 120, and therefore to guarantee a low latency data transmission, the eSNN architecture should be chosen such that the number of neurons in its output layer does not exceed the capacity of the SER 104. This provides that the encoded representation at the output of the eSNN 132 may be packed by the SER 104 and transferred to the external device.

The sensor device 100 may further be configured to communicate with the external device 120, e.g., the edge gateway device 120, over a short range. Thus, the sensor device 100 may provide direct communication with the edge gateway device 120 using wired communication or short-range wireless communication. This may provide that a time used for the transfer of the data packet from the sensor device 100 to the edge gateway device 120 may (e.g., always) be the same or substantially the same. Hence, the sensor device 100 may not need to provide a time stamp for the data packet. Rather, the data packets may be (e.g., immediately) transmitted to the edge gateway device 120, which may then be able to relate the data packets in time to each other based on a time of receipt of the data packets. This implies that no clock synchronization between the sensor device 100 and edge gateway device 120 is used and allows an internal clock generator (not shown in the figure) to generate the clock signal intermittently without knowing a time that has passed between generation of sequential data packets.

The sensor device 100 may further include a memory (also not shown in the figure). The use of memory implies that bigger data packets may be used for communicating information acquired from longer time frames. Thus, using the memory, the sensor device 100 may be configured to generate fewer but bigger data packets. Since each data packet may need header(s) and general information, the use of smaller data packets may imply that less information is communicated from the sensor device 100. However, the memory takes up physical space in the sensor device 100. Thus, if the sensor device 100 is to be as small as possible, the memory may be omitted. In such a case, the sensor device 100 is configured to packetize the encoded representation and output a data packet to an external device in real time after the data packet has been generated. This implies that the external device may receive the data packets in real time. Thus, the external device may associate a timing of an event detected by a sensor with a time stamp (e.g., time point) of receipt of the data packet. The data packet may not include a time stamp and a clock of the sensor device 100 for packetizing data and may not be synchronized with a clock of the external device. This implies that the complexity of achieving clock synchronization between the plurality of sensors and a receiving external device may be avoided.

The sensor device 100 may be implemented as an integrated circuit. For example, the sensor device 100 may be implemented as an Application-Specific Integrated Circuit (ASIC) or a Field-Programmable Gate Array (FPGA). However, the sensor device 100 may not be implemented in a single integrated circuit. The sensor device 100 may include two or more integrated circuits, with its components distributed over the two or more integrated circuits.

The sensor device 100 may be arranged in a common housing with the set of sensors. The sensor device 100 may alternatively be arranged in a separate housing from the set of sensors, wherein the sensor device 100 is arranged to receive signals directly through a wired connection from the set of sensors. The sensor device 100 may be arranged close to the set of sensors so that signals from the set of sensors may be transferred a short distance between the set of sensors and the ADCs 102a-n. This implies that power consumption for the transfer of signals may be low.

Further, the sensor device 100 may be arranged in a housing having limited power capacity, such as being powered by a battery. This may be used as the sensor device 100 may be arranged close to the set of sensors or even integrated with the set of sensors. Therefore, the intermittent operation of the sensor device 100 provided by a clock generator may be (e.g., highly) useful, since low power consumption of the sensor device 100 may be used for providing (e.g., ensuring) a long lifetime of the sensor device 100.

Further, the housing of the sensor device 100 may allow the sensor device 100 to be worn or to be arranged close to the set of sensors, hence allowing wired transfer or short-range wireless transfer of signals from the set of sensors to the sensor device 100. This may be used, for instance, when the sensor device 100 is configured to detect a biological signal and when the set of sensors 10 may be worn or implanted in a body of a human or animal being.

FIG. 1A further shows an edge gateway device 120 for decoding the data from the set of sensors. The edge gateway device 120 is therefore configured to receive a data packet from the sensor device 100. The data packet may be provided to a de-serializer (DES) 124 for unpacking the data packet and thus to extract the one or more encoded representations 133 therefrom. The DES 124 therefore has the same but reverse functionality of the SER 104.

The edge gateway device 120 further includes a decoder (DEC) 134 for decoding event information from the encoded representation 133. The DEC 134 is thus configured to receive the encoded representation 133 from the DES 124 and to decode or to infer the event information therefrom. The DEC 134 may be a deep neural network (dNN), pre-trained for decoding the event information such as a feedforward neural network (FNN), a convolutional neural network (CNN), or a recursive neural network (RNN), such as a gated recurrent unit-based neural network (GRU) or a long short-term memory (LSTM) neural network. Alternatively, the DEC 134 may be a spiking neural network (dSNN), which may implement a biological neuron learning model, such as an integrate-and-fire or a leaky integrate-and-fire or another suitable (e.g., for the purpose) model.

FIG. 3A further shows an example architecture of the DEC 134. In the example, the DEC 134 is a decoding deep neural network comprising three (e.g., fully) connected layers, e.g., an input layer, a hidden layer, and an output layer. Similarly to the ENC 132, depending on the type of sensors in the set and/or the type of information they acquire as well as their number, the DEC 134 may include more than one hidden layer. In the example of FIG. 3A, the encoded representation 133 is fed to respective neurons in the input layer of the decoding neural network DEC 134. As shown in the figure, values of the encoded representation are fed to respective neurons in the input layer of the decoding neural network DEC 134. The neurons in the respective layers apply a linear or a non-linear transformation to the received values in accordance with the learning model. As a result, one or more neurons in the layer fire which subsequently triggers the firing of neurons in the subsequent layers, and thus the output at the output layer of the DEC represents the event information obtained from the sensors.

The edge gateway device 120 may further include a summator 122 configured to reconstruct the data acquired by the sensors. For example, if the event information represents a change in the value of a sensor, the summator will reconstruct the changes observed by the various sensors. If the event information represents the direction of the change as well as the magnitude of the change, the output of the summator 122 will be the signals as acquired by the various sensors. Therefore, the summator 122 is configured to receive the event information and to reconstruct the received event information to detected events.

Similarly to the sensor device 100, the edge gateway device 120 may be implemented as one or more integrated circuits, such as one or more Application-Specific Integrated Circuits (ASIC) and/or a Field-Programmable Gate Arrays (FPGA). That is, the edge gateway device 120 may be implemented in a single integrated circuit with its components distributed over the two or more integrated circuits.

The edge gateway device 120 may be arranged in a housing and which may allow the edge gateway device 120 to be worn or to be arranged close to the sensor device 100, allowing a short-range wireless transfer of signals from the sensor device 100. This implies that power consumption for transfer of signals may be low. This may be used, for instance, when the sensor device 100 is configured to detect a biological signal, e.g., when it is implanted in a body of a human or animal being, and when the edge gateway device 120 may be worn on the body of a human or animal being.

According to example embodiments, the ENC (eSNN) 132 may be implemented in a distributed architecture. In other words, the use of encoding neural network allows for distributed encoding computation. Since each layer of eSNN 132 transfers information via spikes, the encoding computation of the event information may be easily split. FIG. 1B and FIG. 3B show an example where the eSNN 132 is split into two sub-sections, with its first sub-section 132₁ including the layers corresponding to the Layer 1 and Layer 2 of the eSNN of FIG. 3A and remaining on the edge device 100, and its second, residual sub-section 132₂, including the remaining layers of the eSNN 132, e.g., Layer 3 and Layer 4, now integrated in the edge gateway device 120.

Depending on the architecture of the sensing system, the encoding computation may be split differently. For example, an intermediate device may be configured to further encode the partially encoded event information from the sensor device 100 and may communicate the encoded event information to the edge gateway device 120. Further, the split of the encoding SNN 132 may be configured in accordance with the energy used by the sensor device 100 and optionally the intermediate device for the data transmission, so that the overall energy consumption by the respective device 100 meets (e.g., satisfies) the energy requirements.

Employing distributed architecture allows for further reduction of the area of sensor device 100. Further, employing a distributed architecture may also be useful when the event information is (e.g., very) sparce, e.g., event information is obtained at much larger time intervals. In such cases, an SNN with fewer layers may be sufficient to achieve a sufficient compression ratio while meeting the stringent power consumption specifications (e.g., requirement). To maximize the usefulness (e.g., benefits) of sparse event information, the sensor device 100 may be manufactured using>=65 nm semiconductor technology to avoid leak currents in the sensor device.

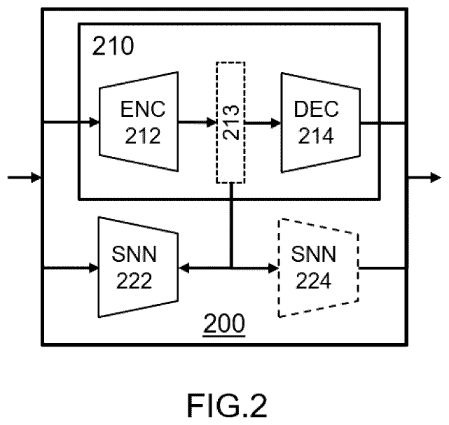

The training of the ENC 132 and the DEC 134 is provided herein with reference to FIG. 2. FIG. 2 shows a neural network training system 200 according to an example embodiment of the present disclosure. The training system 200 includes an encoder-decoder neural network 210 and a SNN 222. The encoder-decoder neural network 210 is a type of deep neural network that performs a sequence-to-sequence transformation. The encoder (ENC) 212 and decoder (DEC) 214 may comprise a deep neural network (dNN), such as a feedforward neural network (FNN), a convolutional neural network (CNN), or a recursive neural network (RNN), such as a gated recurrent unit-based neural network (GRU) and a long short-term memory (LSTM) neural network. As the name suggests, the encoder-decoder neural network 210 includes an encoder neural network 212 and a decoder neural network 214. Both the encoder 212 and decoder 214 include several layers of neurons, such as an input layer, two or more hidden layers, and an output layer. Each neuron in a respective layer is configured to weigh the data at its output in accordance with the weight associated with the neuron. As a result, each layer of neurons performs a transformation of the data at its input, and thus each layer of neurons trains based on the data from the output of the previous layer. The encoder transforms the input data into a different representation, e.g., a latent vector 213. The decoder 214 then takes the latent vector 213 as the input and expands it to the same or different format depending on the functionality.

The architecture SNN 222 may correspond to the ENC 132 of FIG. 1A and FIG. 1B, while the architecture of the decoder neural network 214 may correspond to DEC 134 of FIG. 1A or FIG. 1B. The SNN 222 and the decoder 214 are replicas of the SNN 132 and the decoder 134 of FIG. 1A or FIG. 1B, respectively.

Similarly to the encoder-decoder neural network 210, the encoder (SNN) 212 is a type of deep neural network that performs a sequence-to-sequence transformation. The SNN may implement biological neuron learning models, such as an integrate-and-fire or a leaky integrate-and-fire, or any other suitable (e.g., for the purpose) models. The SNN is a fully-or partially-connected neural network that includes several layers of neurons, such as an input layer, two or more hidden layers, and an output layer. Each neuron in a respective layer is configured to generate an event, for example, a firing or spiking, by performing a neuro-synaptic operation. The type of neuro-synaptic operation depends on the learning model implemented by the SNN. An event may be therefore generated automatically upon performing a neuro-synaptic operation. Alternatively, generating an event by a neuron may be done when a predefined condition is met. For example, such a predefined condition may be based on an accumulation of input data over a certain time interval. An accumulated value may, for example, include a sum of past input data values received during the time interval. A neuron may be configured to fire when such an accumulated value reaches a predefined threshold. That is, a neuron performs may perform weighting as well as an accumulation and a comparison operation. As a result, every layer of neurons performs a non-linear transformation of the data at its input. Similarly to the encoder-decoder neural network 210, the SNN 212 also transforms the input data into a different representation, the latent vector 213.

In an example embodiment, both the encoder-decoder neural network 210 and the SNN 222 are trained to perform a lossless or low-less compression or encoding of event information. Both the encoder-decoder neural network 210 and the SNN 222 are trained using a set of training sequences, e.g., a set of training event information. The training sequences may include event information obtained from one or more sensors at various time instances. Further, the training sequences may include event information obtained using same or similar type set of sensors as in FIG. 1A or FIG. 1B. Alternatively, the training sequences may include event information from benchmark training datasets, such as electrophysiological signals from the mouse brain (https://zenodo.org/records/14449576? preview=1&token=eyJhbGciOiJIUzUxMiJ9.eyJpZCI6ImQxODJlNTU0LWVmMzctNDliMS1h MmEzLTI0N2E4OWZkNWNhNiIsImRhdGEiOnt9LCJyYW5kb20iOiI5ZDVjNmU5MDE5NTc 1MzdlYzY3YmRmODY1NTg1Zjc0ZCJ9.IxfxlGe8jaeK2K4nh699C9Wkg08ogySEqoZj2X -yFH2SpgsqEbBeNVdQlZSwJjYcSRt8OYScK8hsjGMWvA449A). The encoder-decoder neural network 210 and the SNN 222 may be trained by supervised or unsupervised training, e.g., the event information used for training may be labelled or not. For example, the training event information may be provided by the ADCs 102 of FIG. 1A or FIG. 1B and then labelled if supervised training is desired.

In the case of the unsupervised training, at each step of the training, the encoder 212 encodes or compresses a training sequence from the set to derive a latent vector therefrom, e.g., an encoded representation 213 which is a lower dimensional representation of that sequence. The decoder 214 decodes or uncompresses the obtained encoded representation 213 to derive or reconstruct the training sequence. A loss function such as (root) mean square error, mean absolute error, cross-entropy, or other loss functions may be used to derive a reconstruction error by comparing the original training sequence and its reconstructed version. The derived reconstruction error is then used to penalize the encoder-decoder neural network 210 by modifying the weights associated with the neurons in different layers. That is, the weights associated with neurons in one or more layers of the encoder and/or the decoder neural networks may be modified. The above training procedure is performed using the training sequences in the set, and it continues until the reconstruction error reaches a predetermined (e.g., desired) level, concluding the training of the encoder-decoder neural network 210.

The encoder-decoder neural network 210 may be configured to achieve a compression ratio of (e.g., about) 4× (e.g., 4 times) to 15× depending, for example, on the datasets, neural network architecture and the (e.g., required) reconstruction accuracy. The compression ratio and in turn the reconstruction error may be tuned by adjusting the size of the encoded representation or latent vector, or by modifying the architecture of the encoder and the decoder, e.g., by changing the number of hidden layers and/or by changing the number of neurons in the layers. However, reconstruction error may increase with decreasing of the encoded representation. Thus, a balance may be made between the (e.g., desired) compression ratio and the reconstruction error.

After completing the training of the encoder-decoder neural network 210, the latent vector 213 and the set of training sequences is used to train the SNN 222. The same training procedure as above is followed. That is, at each step of the training, the SNN encodes or compresses a training sequence from the set to derive a latent vector or an encoded representation which is a lower dimensional representation of the training sequence. A loss function such as a (root) mean square error, mean absolute error, cross-entropy or other loss functions may be used to derive a reconstruction error by comparing the derived encoded representation with latent vector 213 derived from the encoder-decoder neural network 210. The derived reconstruction error may then be used to penalize the SNN 222 by modifying the conditions at which one or more neurons in the different layers are firing or spiking. Again, the training procedure is performed using the training sequences in the set and until the reconstruction error reaches a predetermined (e.g., desired) reconstruction error to conclude the training of the SNN 222.

Once the training of the SNN 222 is completed, the encoder SNN 212 is deployed on the edge device 100, e.g., the conditions at which the various neurons in the ENC 132 will be used to program a replica SNN 132 deployed or integrated on the edge device 100. The SNN 132 on the edge device 100 may be programmed using the configuration parameters associated with the respective neurons in the SNN 222. This may complete the training procedure for the SNN 132 on the edge device 100. The sensor device 100 may then operate as described above with reference to FIG. 1A and FIG. 1B.

At the same time or subsequently, the decoder neural network (DEC) 214 is deployed on the edge gateway device 120, e.g., the weights associated with the different neurons in the DEC 214 may be used to program the replica DEC 134 deployed or integrated on the edge gateway device 120. The DEC 134 on the edge gateway device may be programmed using the configuration parameters associated with the respective neurons in the DEC 214. This completes the training procedure for the DEC 134 on the edge gateway device 120 and the edge gateway device 120 may then operate as described herein with reference to FIG. 1A and FIG. 1B.

The neural network training system 200 may further include a (e.g., further) SNN 224 trained to perform a decompression or decoding of event information from the encoded representation derived from the ENC (SNN) 212. This decoding SNN 224 may include the same or different architecture as the SNN 212 trained to perform lossless or low-less compression. The (e.g., decoding) SNN 224 may be configured to implement the same or different learning model as the (e.g., encoder) SNN 212. The decoding SNN 224 may be a replica of the decoder neural network DEC 134 of FIG. 1A and FIG. 1B. Both the sensor device and the edge gateway device of FIG. 1A or FIG. 1B may include a SNN for encoding and for decoding, respectively.

The decoding SNN 224 is trained using the same training procedure as provided hereinabove. At each step of the training, the SNN 224 decodes or decompresses the encoded representation to derive or reconstruct the training sequence therefrom. A loss function, such as a (root) mean square error, mean absolute error, cross-entropy, or other loss functions, is used to derive a reconstruction error by comparing the reconstructed training sequence with the original training sequence. The derived reconstruction error is then used to penalize the decoding SNN 224 by modifying the conditions at which one or more neurons in the different layers are firing or spiking. Again, the training procedure is performed using the training sequences in the set and until the reconstruction error reaches a predetermined (e.g., desired) reconstruction error to conclude the training of the SNN 224.

Once the training is completed, the SNN 224 is deployed on the edge gateway device 120 by programming the DEC 134 on the edge gateway device 120 using the configuration parameters associated with the respective neurons in the SNN 224. The sensor device 100 may then operate as described above with reference to FIG. 1A and FIG. 1B.

According to an example embodiment, the devices 100 and 120 may operate in three modes, e.g., a training mode, a normal mode, and a calibration mode.

During the training mode, the sensor device 100 is configured to transmit the events detected by the ADCs via the SER 104. The event information is thus packeted by the SER 104 without being encoded by the SNN. The packaging of the event information may be done using the packaging method as detailed in the European Patent Application No. 23213959.2. Further, the gateway device 120 is configured to receive the transmitted packets which are depacketized by the DES 124. Again, the DES 124 may perform the same but reverse functionality. The unpacked event information is then used to train the eSNN 132 and possibly the dSNN (e.g., DEC) 134 as detailed above with reference to FIG. 2. This implies that the edge gateway device 120 includes the neural network training system of FIG. 2. Alternatively, the edge gateway device may be in communication with the neural network training system via a wired or a wireless connection.

Once the training of the encoding neural network SNN 222 and decoding neural network 214 or 224 is completed, the sensor device 100 and the edge gateway device 120 are configured to operate in a normal mode. The sensor device 100 is configured to detect events, encode the detected events into encoded representation and to packetize them, and the edge gateway device 120 is configured to receive and depacketize the encoded representation and to decode the events therefrom as detailed above with reference to FIG. 1A.

During a calibration mode, the sensor device 100 is configured to transmit the events detected by the ADCs as well as the encoded representation derived by the eSNN. The SER 104 is configured to packet both the output of ADCs and the eSNN 132. Correspondingly, the edge gateway device 120 is configured to receive, depacketize both the detected events and the encoded representation, and decode the encoded representation. The calibration mode may allow the sensor device 100 and the edge gateway device 120 to be pre-trained using one or more benchmark training data sets and then re-trained when set to monitor the object or scene of interest using actual data.

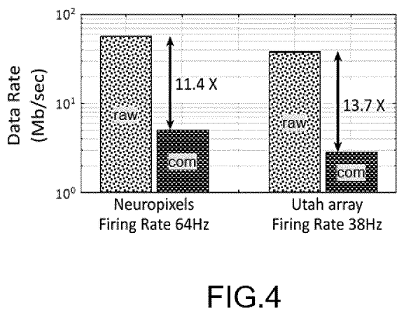

FIG. 4 shows simulation results illustrating the compression ratio achieved with the eSNN 132 of FIG. 3A. The compression ratio achieved with the disclosed approach was tested using two benchmark datasets, e.g., one dataset obtained using a neuro-pixels sensor array with a 64 Hz firing rate and another dataset obtained using a Utah sensor array with a 38 Hz firing rate. As shown, the eSNN 132 achieves compression ratios of 11.4 and 13.7, respectively. The density of electrodes of the sensors, their recording locations in the brain, the ADC resolution, etc. are (e.g., all) different in these two datasets. These results from different datasets show that the encoding and decoding method according to the present disclosure is suitable for datasets from different hardware systems and recording conditions.

As shown in the above examples, by arranging the SNN and the encoder-decoder neural network in a student-teacher configuration, a lightweight SNN may be (e.g., easily) trained to perform lossless or low-less and content-agnostic compression of the event information where underlying statistical distribution of the event information is not available. The use of student-teacher configuration further provides leveraging of the sparsity nature of the event information which may be represented as a spike signal or as the delta-modulated signal. Employing such SNN provides (e.g., allows for) balancing of the compression ratio and power consumption in accordance with the constraints of the (e.g., specific) use while considering the hardware, computational, and communication resources of the sensor or edge and/or the edge gateway devices. The SNN further may provide distributing the compression between the edge devices and the edge gateway devices while offering another degree of freedom when trading-off between computation and communication resources used by either of the devices. The present disclosure thus allows a lightweight SNN integration in sensor edge devices to handle (e.g., large) data in a resource-constrained environment where the power, area, and computing resources are (e.g., highly) constrictive.

Further, the present disclosure may be combined with state-of-the-art communication techniques, such as a body channel communication (BCC) which is a communication technique that uses (e.g., highly) conductive material (e.g., animal bodies) to transfer signals. BCC may achieve both high data rates and low power consumption. Employing the proposed compression technique in sensor edge devices with communication techniques makes these devices even more useful for implantable applications.

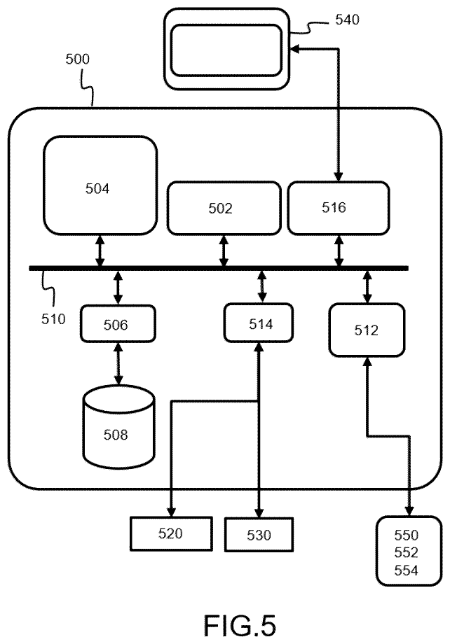

Example embodiments of the present disclosure may be performed with a computing system programmed to perform various steps of the above-described methods and/or the above-described functionalities of the sensor device, edge gateway devices, and/or the neural network training system. The computing system may, for example, include at least one processor and at least one memory. The at least one memory stores program code including computer-executable instructions, which together with the at least one processor, may cause the computing system to perform the above-described example embodiments. The computing system may serve as a partial or full implementation of the sensor device 100, the edge gateway device 120, and/or the training system 130, and the training methods may be (e.g., entirely) implemented as computer-implemented methods. An example of such computing system is shown in FIG. 5. As shown in the figure, the computing system 500 may, in general, be formed as a suitable general-purpose computer and include a bus 510, a processor 502, a local memory 504, one or more optional input interfaces 514, one or more optional output interfaces 516, a communication interface 512, a storage element interface 506, and/or one or more storage elements 508. Bus 510 may include one or more conductors that permit communication among the components of the computing system 500. Processor 502 may include any type of conventional processor or microprocessor that interprets and executes programming instructions. Local memory 504 may include a random-access memory (RAM), or another type of dynamic storage device that stores information and instructions for execution by processor 502 and/or read-only memory (ROM) or another type of static storage device that stores static information and instructions for use by processor 502. Input interface 514 may include one or more conventional mechanisms that permit an operator or user to input information into the computing system 500, such as a keyboard 520, a mouse 530, a pen, voice recognition and/or biometric mechanisms, a camera, etc. Output interface 516 may include one or more conventional mechanisms that output information to the operator or user, such as a display 540, etc. Communication interface 512 may include any transceiver-like mechanism such as one or more Ethernet interfaces that provide computing system 500 to communicate with other devices and/or systems, e.g., other computing devices 550, 552 and 554. The communication interface 512 of computing system 500 may be connected to another computing system through a local area network (LAN), or a wide area network (WAN), such as the internet. Storage element interface 506 may include a storage interface, for example, a Serial Advanced Technology Attachment (SATA) interface or a Small Computer System Interface (SCSI), for connecting bus 510 to one or more storage elements 508, such as one or more local disks, e.g., SATA disk drives, and control the reading and writing of data to and/or from these storage elements 508. Although the storage element(s) 508 above is/are described as a local disk, in general, any other suitable computer-readable media such as a removable magnetic disk, optical storage media such as a CD or DVD, ROM disk, solid-state drives, flash memory cards may be used.

As used herein, the term “circuitry” may refer to one or more (e.g., or all) of the following:
(a) hardware-only circuit implementations such as implementations in (e.g., only) analog and/or digital circuitry; and
(b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and
(c) hardware circuit(s) and/or processor(s), such as microprocessor(s) or a portion of a microprocessor(s), that uses software (e.g., firmware) for operation, but the software may not be present when it is not used for operation.

As a further example, as used in this application, the term “circuitry” also covers an implementation of a hardware circuit or processor (or multiple processors) or a portion of a hardware circuit or processor and its (or their) accompanying software and/or firmware. The term circuitry also covers, for example, a baseband integrated circuit or processor integrated circuit for a mobile device or a similar integrated circuit in a server, a cellular network device, or other computing or network device.

Although the present disclosure has been illustrated by reference to example embodiments, the disclosure is not limited to the details of the foregoing example embodiments, and the present disclosure may include various changes and modifications without departing from the scope thereof. The example embodiments are illustrative and not restrictive.

“Comprising” or “comprise” does not exclude other elements or steps, that the words “a” or “an” do not exclude a plurality, and that a single element, such as a computer system, a processor, or another integrated unit may fulfil the functions of several elements (e.g., recited in the claims). Reference signs in the claims shall not be construed as limiting the respective claims concerned. The terms “first,” “second,” “third,” “a,” “b,” “c,” and the like, when used in the description or in the claims, are introduced to distinguish between similar elements or steps and are not necessarily describing a sequential or chronological order. Similarly, the terms “top,” “bottom,” “over,” “under,” and the like are introduced for descriptive purposes and not necessarily to denote relative positions. The terms so used are interchangeable under some circumstances and example embodiments of the disclosure are capable of operating according to the present disclosure in other sequences, or in orientations different from the one(s) described or illustrated above.

What is claimed is:

1. A computer-implemented method for training a learning model for encoding event information with a learning system comprising a spiking neural network (SNN), the method comprising:
obtaining event information for at least one event, wherein the at least one event corresponds to a change in a value of a sensor from a set of sensors;
deriving an encoded representation from the obtained event information with an encoder-decoder neural network; and
training the SNN with the obtained event information and the derived encoded representation for encoding the event information.

2. The computer-implemented method according to claim 1, wherein the encoder-decoder neural network and the SNN form a teacher-student neural network.

3. The computer-implemented method according to claim 1, wherein deriving the encoded representation comprises training the encoder-decoder neural network using the obtained event information, and wherein the encoder-decoder neural network comprises a deep neural network, wherein the deep neural network is at least one of a feedforward neural network, a convolutional neural network, or a recursive neural network, wherein the recursive neural network is at least one of a gated recurrent unit-based neural network or a long short-term memory neural network.

4. The computer-implemented method according to claim 1, wherein the SNN comprises at least one hidden layer, and wherein the SNN implements an integrate-and-fire model or a leaky integrate-and-fire model.

5. The computer-implemented method according to claim 1, further comprising:
deploying the trained SNN to a sensor device and a trained decoder neural network of the encoder-decoder neural network to an edge gateway device, wherein the deploying comprises obtaining configuration parameters; and
programming a replica SNN deployed on the sensor device and a replica decoder neural network deployed on the edge gateway device with the obtained configuration parameters, and wherein the configuration parameters characterize the trained SNN and the trained decoder neural network.

6. The computer-implemented method according to claim 1, further comprising deploying a first portion of the trained SNN to a sensor device and a second portion of the trained SNN and a trained decoder neural network of the encoder-decoder neural network to an edge gateway device, wherein the deploying comprises obtaining configuration parameters and programming a replica of the first portion of SNN deployed on the sensor device and a replica of the second portion of the SNN and a replica decoder neural network deployed on the edge gateway device with the obtained configuration parameters, and wherein the configuration parameters characterize the trained SNN and the trained decoder neural network.

7. A computer-implemented method comprising obtaining event information characterizing at least one event, wherein the at least one event corresponds to a change in a value of a sensor from a set of sensors to infer encoded representation with an SNN pre-trained by the method according to claim 1.

8. A computer-implemented method for training a learning model for decoding event information with a learning system comprising a spiking neural network (SNN), the method comprising:
obtaining event information characterizing at least one event, wherein the at least one event corresponds to a change in a value of a sensor from a set of sensors;
deriving an encoded representation from the obtained event information with an encoder-decoder neural network; and
training the SNN with the obtained encoded representation and the derived event information for decoding the encoded representation.

9. The computer-implemented method according to claim 8, wherein the encoder-decoder neural network and the SNN form a teacher-student neural network.

10. The computer-implemented method according to claim 8, wherein deriving encoded representation comprises training the encoder-decoder neural network with the event information and wherein the encoder-decoder neural network comprises a deep neural network, wherein the deep neural network is at least one of a feedforward neural network, a convolutional neural network, or a recursive neural network, wherein the recursive neural network is at least one of a gated recurrent unit-based neural network or a long short-term memory neural network.

11. The computer-implemented method according to claim 8, wherein the SNN comprises at least one hidden layer and wherein the SNN implements an integrate-and-fire model or a leaky integrate-and-fire model.

12. The computer-implemented method according to claim 8, further comprising deploying the trained SNN to an edge gateway device, wherein the deploying comprises obtaining configuration parameters to program a replica SNN on the edge gateway device with the obtained configuration parameters, and wherein the configuration parameters characterize the trained SNN.

13. A computer-implemented method comprising:
obtaining an encoded representation of event information characterizing at least one event, wherein the at least one event corresponds to a change in a value of a sensor from a set of sensors; and
inferring therefrom the event information with a SNN pre-trained by the method according to claim 8.

14. A sensor device comprising a spiking neural network (SNN), pre-trained by the method according to claim 1, wherein the SNN is configured to receive event information characterizing at least one event and to infer an encoded representation of the received event information, and wherein the at least one event corresponds to a change in a value of a sensor from a set of sensors.

15. The sensor device according to claim 14, wherein the SNN is pre-trained according to the method of claim 6 to partially encode the received event information.

16. An edge gateway device comprising a decoder neural network, pre-trained by the method according to claim 1 or a SNN pre-trained by the method according to claim 8 and configured to receive encoded representation of event information characterizing at least one event and to infer the event information encoded, wherein the at least one event corresponds to a change in a value of a sensor from a set of sensors from.

17. The edge gateway device according to claim 16, wherein a SNN is pre-trained by the method according to claim 6 and is configured to receive partially encoded representation of the event information and to output the encoded representation of the event information.

18. A neural network training system comprising at least one processor and at least one memory including computer program code, wherein the at least one memory, the computer program code and at least one processor are configured to cause the neural network training system to perform the computer-implemented method according to claim 1 or the computer-implemented method according to claim 8 when the computer program code is run on the neural network training system.

19. A computer program product comprising computer-executable instructions for causing at least one computer to perform the method according to claim 1 or the method according to claim 8 when the program is run on the at least one computer.

20. A computer readable storage medium comprising the computer program product according to claim 19.
